(19) United States
(12) Patent Application Publication
(10) Pub. No.: US 2019/0282895 A1
(43) Pub. Date: Sep. 19, 2019

(54) CONTROL SHARING FOR INTERACTIVE EXPERIENCE

(71) Applicant: Microsoft Technology Licensing, LLC, Redmond, WA (US)

(72) Inventors: Sreekar CHOUDHARY, Bothell, WA (US); John HENSON, Seattle, WA (US); Dylan Keith GARRETT, Seattle, WA (US); Hutchenson Judson WHITE, Maple Valley, WA (US)

(73) Assignee: Microsoft Technology Licensing, LLC, Redmond, WA (US)

(21) Appl. No.: 15/965,477

(22) Filed: Apr. 27, 2018

Related U.S. Application Data
(60) Provisional application No. 62/642,540, filed on Mar. 13, 2018.

(51) Int. Cl. A63F 13/34; A63F 13/86; A63F 13/26; A63F 13/31; A63F 13/73

(52) U.S. Cl. CPC A63F 13/34; A63F 13/86; A63F 13/87; A63F 13/31; A63F 13/73; A63F 13/26

(57) ABSTRACT

A method for controlling an interactive experience includes receiving local control inputs at a computing device facilitating the interactive experience and providing the local control inputs to the interactive experience, the control inputs being provided by a first input device associated with a primary experience participant. Audiovisual content associated with the interactive experience is provided to a plurality of remote viewer computing devices over a network. The computing device receives a command to initiate control sharing with a remote viewer and, over the network, receives remote control inputs from a second input device associated with the remote viewer, the second input device being physically distinct from the first input device. The remote control inputs are provided to the interactive experience as if the remote control inputs had originated from the first input device, the first input device still being associated with the primary experience participant.

### CROSS REFERENCE TO RELATED APPLICATIONS

This application claims priority to U.S. Provisional Patent Application Ser. No. 62/642,540, filed Mar. 13, 2018, the entirety of which is hereby incorporated herein by reference for all purposes.

### BACKGROUND

Computers can enable a variety of different interactive experiences. Video games are one example, in which one or more players provide inputs to the computer to interact with a virtual world generated by the computer. Other interactive experiences may include one or more individuals using a computer to interact with the real world, for example to control a machine or robot. In any case, audiovisual content associated with an interactive experience may be provided over a network to interested viewers, who may have the ability to interact with any participants in the interactive experience.

### BRIEF DESCRIPTION OF THE DRAWINGS

FIG. 1 shows an example user interface presented to a primary experience participant.

FIG. 2 illustrates an example method for controlling an interactive experience.

FIG. 3 illustrates an example user interface presented to a remote viewer.

FIG. 4 schematically illustrates transmission of remote control inputs over a network.

FIG. 5 schematically shows an example computing system.

### DETAILED DESCRIPTION

Interactive experiences will typically have one or more experience participants who are capable of interacting with and influencing the outcome of the interactive experience. In the example of a video game, the experience participants will typically be one or more players and viewers of the video game. Furthermore, as discussed above, in some cases audiovisual content from an interactive experience may be broadcast live to one or more remote viewers over a network. In an example scenario, a primary experience participant playing a video game (i.e., a “broadcaster” or “player) may choose to broadcast their live gameplay over the Internet for viewing by interested remote viewers around the world.

Remote viewers often have some ability to interact with the primary experience participant(s) of the interactive experience, for example by providing text questions or comments in a chat interface. However, regardless of the interactivity options provided to the remote viewers, the distinction between remote viewer and experience participant is typically preserved. In other words, only the experience participant(s) control the video game (or other interactive experience), while the remote viewers are typically only passive observers.

The present disclosure is directed to control sharing for interactive experiences. A local computing device facilitating the interactive experience receives local control inputs from a primary experience participant. However, the local computing device is also configured to accept remote control inputs from a remote viewer over a network. Accordingly, when desired, the primary experience participant can relinquish and/or share partial or full control of the interactive experience with one or more remote viewers. In other words, the remote viewers may provide control inputs to the video game just as the player would. Furthermore, the remote control inputs are provided to the interactive experience such that they appear, from the perspective of the interactive experience, to originate from the primary experience participant. This allows virtually any interactive experience (e.g., video game) to support control sharing as described herein, without requiring special effort on the part of the experience's creators or organizers. This represents an improvement to the functioning of the local computing device, as it adds entirely new functionality to software (e.g., video game software) running on the local computing device, without requiring extra effort from the creators of such software. For example, control sharing as described herein allows multiple players to collaboratively control a video game, even when the video game itself only supports one player at a time.

The control sharing techniques discussed herein will primarily be described in the context of video game broadcasting. However, it will be understood that control sharing may be implemented for any suitable interactive experience that one or more participants can influence by providing inputs to a computer. As discussed above, such experiences can include video games as well as, for example, individuals controlling a robot or machine (e.g., remotely piloted drone), computer software other than video games (e.g., educational or productivity software), etc. In other words, while most of the examples herein are presented in the context of video games, the control sharing techniques described herein can be extended to any type of shareable or streamable software experience.

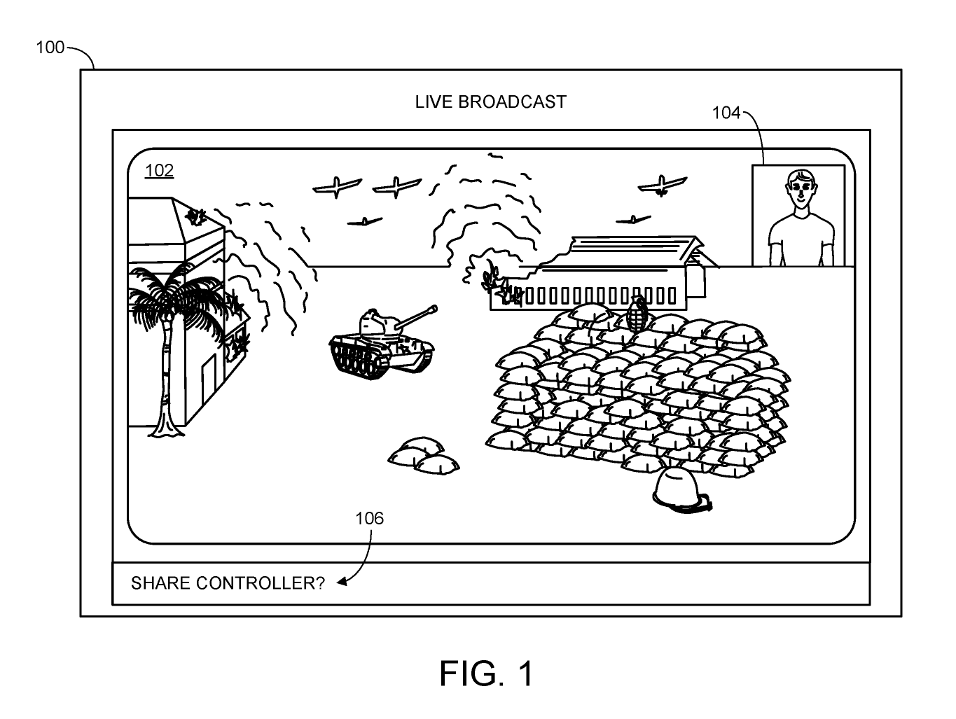

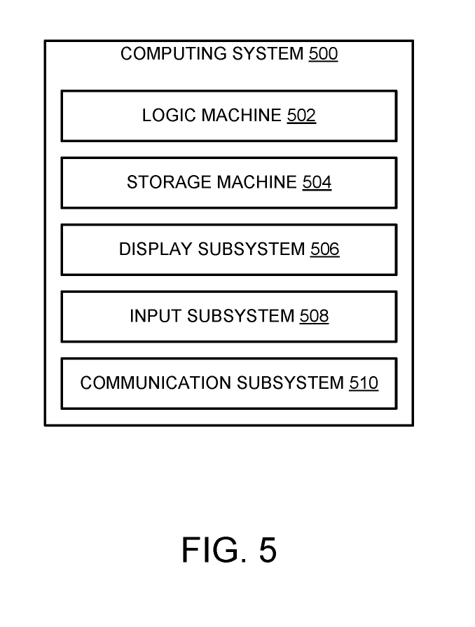

FIG. 1 depicts an example user interface 100 including audiovisual content 102 of an interactive experience, taking the form of a video game. User interface 100 may be rendered and/or displayed by any suitable computing system. For example, user interface 100 may be rendered by a video game console, personal smartphone, wearable device, tablet, laptop, desktop, server, augmented/virtual reality device, media center, etc. In some examples, user interface 100 may be rendered and/or displayed by computing system 500 described below with respect to FIG. 5. Furthermore, in examples where the interactive experience takes place in the real world (e.g., remote control of a robot), then the audiovisual content need not be rendered or generated, but rather may be captured by suitable camera hardware, and optionally compressed, edited, processed, etc., by a suitable computing system, such as computing system 500.

In FIG. 1, the interactive experience is a video game. Audiovisual content 102 of the video game is being provided (i.e., “broadcast” or “streamed”) to one or more remote viewers over a network. Furthermore, a primary experience participant 104 is controlling the video game—e.g., by providing control inputs to a computing device.

It will be understood that user interface 100 is presented as a nonlimiting example, and alternative user interfaces may differ in numerous ways. For example, though FIG. 1 shows a real-world feed of primary experience participant 104, this is not required. Alternative user interfaces may instead use a static image of the primary experience participant, an avatar, thumbnail, or symbol associated with the primary experience participant, or omit a visible representation of the primary experience participant altogether. Similar changes may be made to other elements of user interface 100. Thus, in other examples, a user interface may include more/fewer/different components and interactable elements, having any suitable size and position.

In the example of FIG. 1, participant 104 is the only individual controlling the interactive experience. However, as discussed above, it may in some cases be desirable for the primary experience participant to at least partially share or relinquish control of the interactive experience to one or more remote viewers. This can be entertaining for both the primary experience participant as well as the remote viewers, and can foster a desirable sense of inclusion and community among the various individuals associated with the interactive experience (e.g., participants and remote viewers). Furthermore, it improves the functioning of the computing device, as it enables multiple users to collaboratively control software features that otherwise would only support one user, allowing the software to be more efficiently operated (e.g., as multiple users working together may be better at playing a video game than a single user alone), and allowing software that only supports a single user to suddenly support multiple users at once, without requiring extra effort from the software developers themselves.

Accordingly, user interface 100 also includes a “share controller” option 106 that may be selected by either or both of the player and remote viewer(s) to begin control sharing during broadcasting of the interactive experience. After activation of the share controller option, one or more remote viewers may be given partial or complete control over the interactive experience. In other words, a remote viewer of the interactive experience (e.g., video game broadcast) may become a new experience participant, at least temporarily, and may in effect “replace” the primary experience participant.

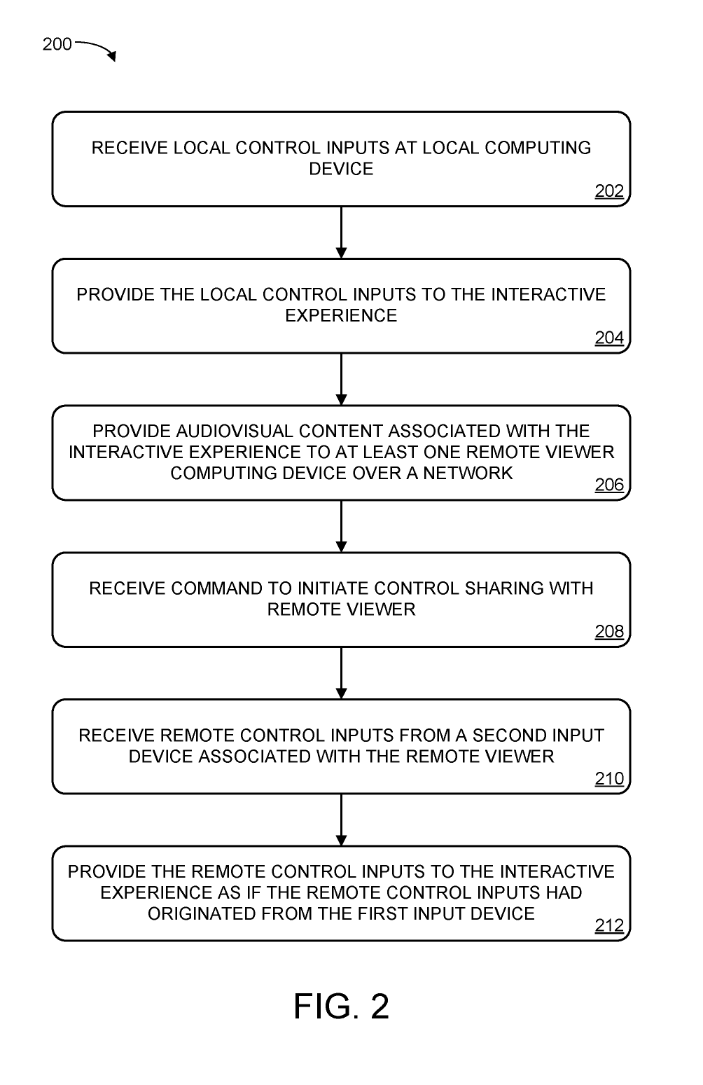

FIG. 2 illustrates an example method 200 for controlling an interactive experience that may enable the control sharing functionality described above. Method 200 may be implemented using any suitable computer hardware. For example, method 200 may be implemented using any combination of video game consoles, personal smartphones, wearable devices, tablets, laptops, desktops, server, augmented/virtual reality devices, media centers, etc. Furthermore, the various devices discussed with respect to method 200 (i.e., the local computing device and remote viewer computing devices) need not each have the same form factor. In some examples, any or all of these devices may be implemented as computing system 500 described below with respect to FIG. 5.

At 202, method 200 includes receiving local control inputs at a local computing device facilitating the interactive experience, the control inputs originating from a first input device associated with a primary experience participant. As discussed above, control sharing may be implemented with a variety of different interactive experiences. In some examples, the interactive experience may be a video game. As used herein, “video game” refers to any event taking place in a virtual space that experience participants (e.g., players) can interact with. For example, as in FIG. 1, “video game” can refer to the execution of video game software by one or more computing devices, causing the rendering of audiovisual content.

Further, it will be understood that a video game, or other interactive experience, may have any suitable number of players or participants. For example, a video game could refer to a single individual playing a video game, or thousands of people all interacting in an online virtual space.

The term “primary experience participant,” as used herein, will typically refer to the individual managing or controlling the broadcasting of audiovisual content (i.e., a “broadcaster” or “streamer”). Thus, even when the interactive experience has multiple participants or players, there will typically only be one primary experience participant. Furthermore, the primary experience participant is able to provide local control inputs to the local computing device. With regard to “local control inputs” and “local computing device,” the word “local” is only used to distinguish the control inputs provided by the primary experience participant from control inputs provided by remote viewers. Thus, the primary experience participant need not necessarily be physically near to the local computing device. While this may be true in some cases, in other cases the primary experience participant's control inputs may be sent to a physically distant computing device (e.g., server) that is facilitating the interactive experience.

Depending on the nature of the local computing device and first input device, the local control inputs may be received in any suitable way. For example, the local control inputs may be received via a wired connection, over a wireless channel, derived from sensor data (e.g., a microphone or camera), received over a network (e.g., the Internet), etc.

The local control inputs and first input device may each take any suitable forms. For example, as indicated above, the first input device may be a video game controller, computer mouse/keyboard, touch screen interface, vocal interface, or other suitable input device. Furthermore, the control inputs may be describe the state of physical hardware components (e.g., button press status, control stick or trigger displacements), the location of input (e.g., the two-dimensional position of a touch input, the current screen position of a computer cursor) a specific desired gameplay action (e.g., move forward, use item), etc.

The first input device may be associated with the primary experience participant in any suitable way. In a basic scenario, the primary experience participant may be designated as “player 1,” while the first input device is a video game controller plugged into a first controller port, or transmitting on a first wireless communication channel. In other examples, the first input device may be associated with a currently logged-in username or profile, associated with a known owner of the first input device, associated with a biometrically-identified experience participant (e.g., via fingerprint or voice recognition), etc.

Continuing with FIG. 2, at 204, method 200 includes providing the local control inputs to the interactive experience. This will typically involve providing the control inputs to a software application running on the local computing device that is specific to the interactive experience. For instance, the control inputs may be received at a firmware layer of the local computing device and undergo some amount of processing or analysis (e.g., to parse human speech or identify touch gestures) to transform the control inputs into a form that is understandable by the interactive experience. In other examples the control inputs may be passed directly to the interactive experience with little to no modification. In the example of a video game, the state of the video game software may be altered by the provided control inputs. For example, the local control inputs may cause the local computing device to begin or end a gaming session, make selections in a menu, cause an in-game avatar to perform designated actions, etc.

At 206, method 200 includes providing audiovisual content associated with the interactive experience to at least one remote computing device over a network. In other words, as the interactive experience unfolds, audiovisual content associated with the interactive experience may be provided to one or more remote viewers. This may be referred to herein as a “broadcast.” For example, in the context of a video game, audiovisual content rendered by the video game application may be broadcast over the Internet to remote viewers around the world.

The live broadcast may be encoded and transmitted in any suitable way, for example using any suitable compression protocol, codec, etc. In some examples and depending on the nature of the video game, the broadcast may comprise raw output of a video game application or other suitable software, which may be processed/modified/rendered by a broadcasting service and/or a different suitable device. In other words, the video game device may transmit a data stream representing the video game that includes or is useable to produce the broadcast. In other examples, the broadcast may comprise a representation or copy (recorded via screen capture or similar technologies) of the visual content displayed to a participant in the video game. The video stream may additionally or alternatively include footage of real-world places or objects. For example, the video stream may include recording of real-world events, a live stream of a player's/broadcaster's face, etc.

At 208, method 200 includes receiving a command to initiate control sharing with a remote viewer. This command may be provided in any of a variety of suitable ways, depending on the implementation. In a typical example, the control sharing command will be provided by the primary experience participant during gameplay by pressing a button or interacting with a user interface element (e.g., share controller option 106 in FIG. 1). The primary experience participant either may select one or more specific viewers to share control with, automatically share control with the first viewer or viewers who request control sharing, initiate a poll or competition among viewers for who deserves to share control with the player, etc. In some examples, a viewer may request to share control while the player is actively playing. This may provide the player with a notification that one or more viewers are interested in sharing control of the video game.

At 210, method 200 includes receiving, over the network, remote control inputs from a second input device associated with the remote viewer, the second input device being physically distinct from the first input device. In other words, once control sharing has begun, the remote viewer may use their own input device to provide control inputs to their own remote viewer computing device. For example, viewer controller 210 may take the form of a dedicated video game controller that transmits remote control inputs over the network via a gamepad application programming interface (API) of a web browser or viewer application. The second input device is physically distinct from the first computing device, which simply means that the two input devices are different, and not simply the same input device being passed from person to person.

As with the local computing device, first input device, and local control inputs, the remote computing device and control inputs, as well as the second input device, may each take any suitable form. In some cases, the first input device may have a different form factor from the second input device. For example, the first input device may be a video game controller, while the second input device is a computer mouse and keyboard, touch screen interface, vocal interface, etc.

In some examples, the remote viewer computing device may present a graphical user interface to the remote viewer, the graphical user interface including virtual controls that mimic a layout of a video game controller. By interacting with the virtual controls (e.g., via a computer mouse or touchscreen), the remote viewer may provide the remote control inputs to the remote viewer computing device, and therefore to the local computing device and ultimately the interactive experience.

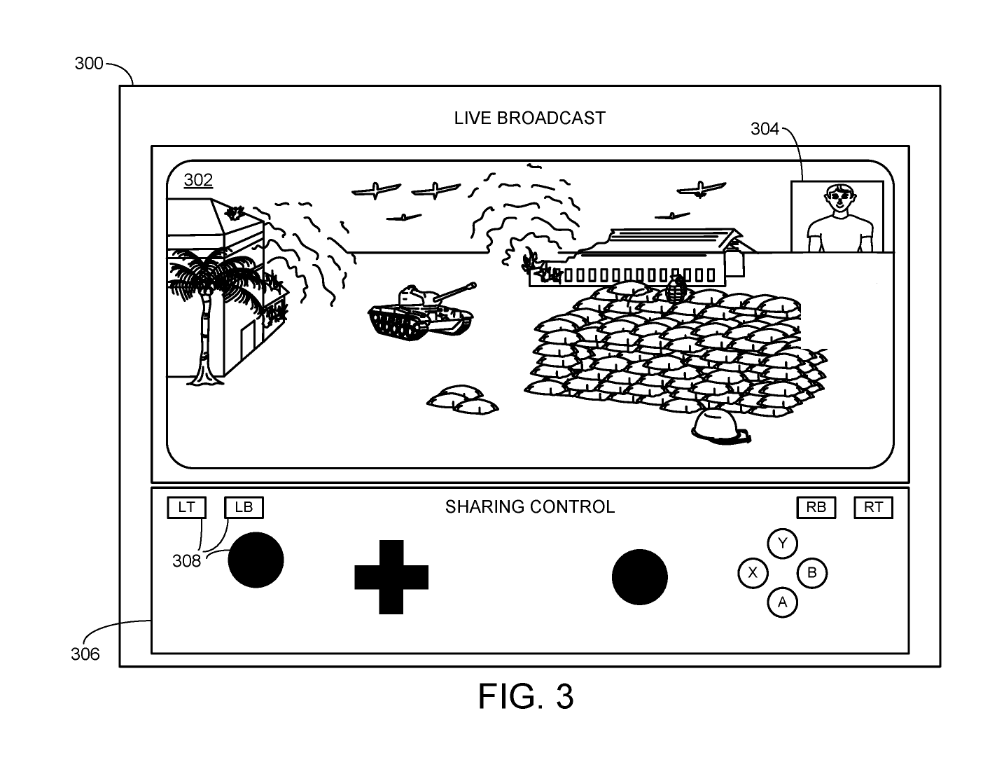

This is illustrated in FIG. 3, which shows an example user interface 300 that may be presented to a remote viewer. As shown, user interface 300 includes audiovisual content 302, which is audiovisual content output by a video game application running on local computing device. User interface maintains a real-world feed 304 of the primary experience participant, who may remain visible to the remote viewers even as one or more remote viewers are controlling the interactive experience. Interface 300 further includes a virtual game controller 306 that the viewer may interact with to provide control inputs to the video game. Specifically, virtual controller 306 includes several virtual controls 308 that mimic a layout of a physical game controller. The remote viewer may interact with the virtual controls (e.g., by clicking on controls with a computer mouse or tapping on controls with a touch screen) to provide the remote control inputs. In this manner, even when the remote viewer lacks a dedicated physical input device, they may still provide remote control inputs to the interactive experience in a manner that feels familiar and intuitive. As discussed above, however, the remote viewer may provide remote control inputs to the interactive experience in any suitable way, and virtual controller 306 is merely a non-limiting example.

Returning to FIG. 2, at 212, method 200 includes providing the remote control inputs to the interactive experience as if the remote control inputs had originated from the first input device. Furthermore, the first input device is still associated with the primary experience participant. In other words, from the perspective of the interactive experience, there is no difference between the local control inputs provided by the primary experience participant and the remote control inputs provided by the remote viewer.

As an example, the local computing device may maintain a virtual, internal input device. As the first input device is manipulated, the state of the virtual internal input device may be changed, and these changes relayed to the interactive experience software. As remote viewer inputs are received by the local computing device, the remote viewer inputs may similarly change the state of the internal input device, and these changes may similarly be relayed to the video game software. In this manner, virtually any video game (or other interactive experience) can support multiple participants even when not explicitly designed to support multiplayer settings.

In some examples, the remote viewer inputs may be relayed through the first input device before being provided to the interactive experience software. For example, upon being received by the local computing device, the remote viewer inputs may be transmitted to the first input device, which then transmits the remote viewer inputs back to the local computing device in the same manner as the local control inputs, just as if the primary experience participant had physically manipulated the first input device. In some examples, the remote viewer inputs may be transmitted directly to the first input device from the network, without first passing through the local computing device.

Furthermore, when the interactive experience is a video game, control sharing may be used to emulate traditional local multiplayer gameplay in a remote broadcast scenario. For example, the primary experience participant (i.e., primary video game player) may choose to share a first game controller with a remote viewer, then begin using a second game controller of their own. In this manner, the remote viewer remotely uses the first game controller to play the video game (e.g., to control a first character), while the primary experience participant uses the second game controller (e.g., to control a second character).

In some cases, sharing control with a particular remote viewer may provide the remote viewer with complete control over the interactive experience. In other words, the interactive experience may be configured to support a plurality of control inputs, and the remote viewer may have access to the entire plurality of control inputs. In other cases, however, the remote viewer's control over the interactive experience may be restricted to only a subset of the control inputs supported by the interactive experience. For example, the remote viewer may be prevented from accessing any system or pause menus. Additionally, or alternatively, the viewer may only be granted control over certain specified gameplay actions—e.g., firing a weapon or using an item. This may be done at the system level—for instance by only allowing the viewer to use certain control inputs (e.g., controller buttons)—and/or at the video game software level. In some examples, the subset of control inputs permitted to the remote viewer may be specified in advance or on-the-fly by the primary experience participant.

Control of the interactive experience may be shared between any number of different participants/remote viewers. For example, while allowing a remote viewer to control the interactive experience, the primary experience participant may retain partial or complete control, allowing the primary experience participant to continue performing gameplay actions if they wish. In other words, even while control sharing is enabled, the local computing device may continue to receive local control inputs provided by the primary experience participant from the first input device, and provide these local control inputs to the interactive experience in tandem with the remote control inputs.

Furthermore, control may be shared with multiple remote viewers at once, providing each of the different remote viewers with partial or complete control over the video game. In other words, even as a first remote viewer is providing remote control inputs, the local computing device may receive second remote control inputs from a second remote viewer. The remote control inputs from each of the first and second remote viewers may be provided to the interactive experience as if they had originated from the first input device. In this manner, multiple individuals can collaborate to control the interactive experience. For example, individuals may take complete control over a video game to complete challenges or environments at which they feel personally proficient, or each individual may focus on performing specific gameplay actions (e.g., the primary experience participant focuses on moving throughout the environment, while a remote viewer focuses on using weapons).

When control is shared with multiple remote viewers at once, in some examples, each remote viewer may be restricted to providing a different subset of control inputs. In other words, if the primary experience participant has access to a plurality of control inputs, then the first remote viewer may be restricted to providing only a subset of the plurality of control inputs, and the second remote viewer may be restricted to providing an entirely different subset of control inputs than the first remote viewer. For instance, one remote viewer may be restricted to firing weapons, while a second remote viewer is only able to use special items.

In some situations, allowing two or more individuals (experience participants and/or remote viewers) to effectively share the same input device can result in the video game software (or other interactive experience software) receiving conflicting control inputs. For instance, the primary experience participant may direct an in-game character to move forward, while a remote viewer may direct the in-game character to move backward. Such conflicts may be handled in any number of suitable ways. For instance, control inputs may be interpreted on a “first-come, first-served” basis, meaning whichever control input is received first is the one that the interactive experience software implements. In other examples, conflict resolution may be used to, for example, prioritize control inputs received from the primary experience participant, or merge conflicting control inputs into a hybridized input.

When control inputs are transmitted over a network, such as when a remote viewer is providing control inputs during control sharing, some amount of network latency will be introduced. Accordingly, during control sharing, a message or warning may be transmitted to remote viewers warning that latency can interfere with their ability to control the interactive experience. In some cases, such a message may only be transmitted for certain types of experiences—i.e., those that are more likely to be affected by high latency. Network latency can be reduced by using high-speed network connections and by using a broadcasting service that features low latency.

The primary experience participant will typically retain control over broadcast and control sharing settings even when a remote viewer is controlling the video game. For example, the primary experience participant will typically have the ability to disable control sharing at any time, thereby recovering exclusive control over the interactive experience. In other examples, however, the individual in charge of control sharing and the primary experience participant may be different individuals.

Control sharing may be enabled and used for any suitable length of time, depending on participant and remote viewer desires. In various examples, a primary experience participant may enable control sharing sparingly, for example allowing a chosen remote viewer to control the experience for a few minutes, or the primary experience participant may allow dozens of different remote viewers to control the game over the course of the broadcast. In some examples, each remote viewer may be allotted a limited amount of time during which they can control the experience, allowing the primary experience participant to establish a control sharing queue for their remote viewers.

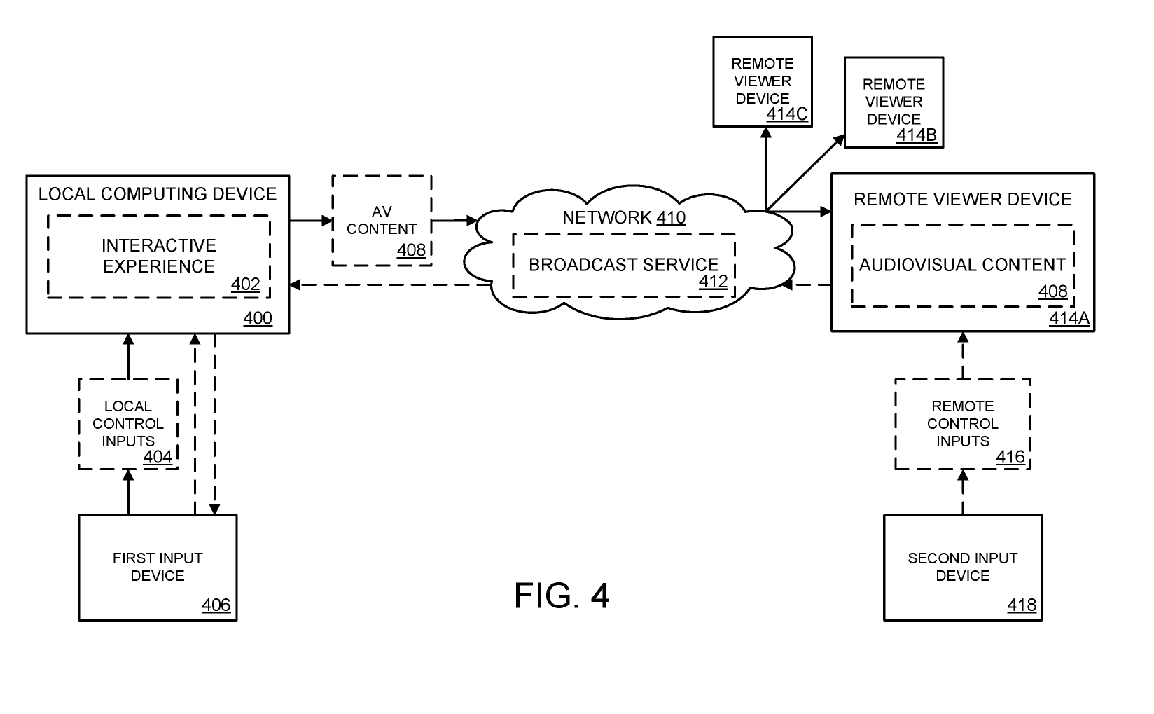

FIG. 4 schematically illustrates transmission of remote control inputs over a network. Specifically, FIG. 4 shows a local computing device 400, which may be any suitable computing device useable to enable an interactive experience 402. For example, device 400 may be a personal computer or video game console that is executing video game software and rendering resulting audiovisual content. In a different example, the local computing device may be a server computer associated with an online gaming service that is executing video game software and thereby providing a virtual space in which one or more players are interacting or competing. The local computing device may take on other suitable forms depending on the nature of the interactive experience itself. In general, the local computing device will be any suitable computing device that is capable of facilitating an interactive experience, receiving local and remote control inputs, and providing audiovisual content over a network. For example, the local computing device may be implemented as computing system 500 described below with respect to FIG. 5.

As shown, local computing device 400 is accepting local control inputs 404 from a first input device 406. As discussed above, the first input device may take on any suitable form, and need not even be physically separate from the local computing device. As examples, first input device 406 may be a dedicated video game controller, computer mouse/keyboard, on-screen interface, vocal command interface, etc.

Also shown in FIG. 4 is audiovisual content 408 being output or generated by the interactive experience. Such audiovisual content may be broadcast or streamed substantially live. As used herein, the word “live” indicates that the broadcast is representing events that are taking place substantially in real-time.

Audiovisual content 408 is transmitted via a network 410 to a plurality of remote viewer devices 414. Network 410 may take any suitable form such as, for example, the Internet. As discussed above, in some cases the broadcast may be facilitated or modified by a broadcasting service 412, which may host, augment, or manage a plurality of different interactive experience broadcasts. A broadcasting service may be maintained by a video game studio, hardware manufacturer, third party, etc. Furthermore, the audiovisual content may be transmitted to any number of remote viewer devices, including only one.

As with local computing device 400, remote viewer devices 414A-414C may take any suitable form, and need not each have the same form factor as each other or as the local computing device. For example, remote viewer devices 414 may be implemented as any combination of personal computers, video game consoles, mobile phones, tablets, wearable devices, media centers, etc. In some examples, remote viewer devices 414 may be implemented as computing system 500 described below with respect to FIG. 5.

Upon receiving audiovisual content 408 via network 410, remote viewer device 414A renders and displays the audiovisual content to a remote viewer. As discussed above, this will typically include audiovisual content output or generated by interactive experience software running on local computing device 400, and may optionally include other content, such as interface elements, real-world video footage, etc.

Remote viewer device 414A is receiving remote control inputs 416 from a second input device 418. When control sharing is enabled, as discussed above, second input device 418 is useable by the remote viewer to transmit remote control inputs to player device 400, where they are ultimately provided to the interactive experience just as if they had originated from the first input device. As discussed above, the remote control inputs may optionally be relayed through the first input device before being provided to the interactive experience.

As with first input device 406, second input device 418 may take any suitable form, and need not have the same form factor as first input device 406. As examples, second input device 418 may take the form of a dedicated video game controller, computer mouse/keyboard, vocal interface, on-screen interface (e.g., simulated controller), and/or may take other suitable forms provided it is useable to transmit remote control inputs to local computing device 400.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows a non-limiting embodiment of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices.

Computing system 500 includes a logic machine 502 and a storage machine 504. Computing system 500 may optionally include a display subsystem 506, input subsystem 508, communication subsystem 510, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally, or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 implemented to perform a particular function. In some cases, a module, program, or engine may be instantiated via logic machine 502 executing instructions held by storage machine 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server- computing devices.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

In an example, a method for controlling an interactive experience comprises: receiving local control inputs at a local computing device facilitating the interactive experience, the control inputs originating from a first input device associated with a primary experience participant; providing the local control inputs to the interactive experience; providing audiovisual content associated with the interactive experience to at least one remote viewer computing device over a network; receiving a command to initiate control sharing with a remote viewer; over the network, receiving remote control inputs from a second input device associated with the remote viewer, the second input device being physically distinct from the first input device; and providing the remote control inputs to the interactive experience as if the remote control inputs had originated from the first input device, the first input device still being associated with the primary experience participant. In this example or any other example, the first input device has a different form factor from the second input device. In this example or any other example, the first input device is a video game controller. In this example or any other example, the remote viewer computing device is configured to provide a graphical user interface to the remote viewer, the graphical user interface including virtual controls that mimic a layout of a video game controller, the virtual controls being manipulable by the remote viewer to provide the remote control inputs. In this example or any other example, the remote control inputs are relayed through the first input device before being provided to the interactive experience. In this example or any other example, the interactive experience is configured to support a plurality of control inputs, and the remote viewer is restricted to providing only a subset of control inputs of the plurality. In this example or any other example, the subset of control inputs permitted to the remote viewer is specified by the primary experience participant. In this example or any other example, the method further comprises receiving second remote control inputs from a second remote viewer, and providing the second remote control inputs to the interactive experience as if the second remote control inputs had originated from the first input device. In this example or any other example, the remote viewer and the second remote viewer each are restricted to providing only a subset of control inputs of a plurality of control inputs supported by the interactive experience, the second remote viewer being restricted to providing a different subset of control inputs than the remote viewer. In this example or any other example, the method further comprises continuing to receive local control inputs provided by the primary experience participant from the first input device, and providing the local control inputs to the interactive experience in tandem with the remote control inputs. In this example or any other example, the interactive experience is a video game.

In an example, a computing system comprises: a logic machine; and a storage machine holding instructions executable by the logic machine to: receive local control inputs at a local computing device facilitating the interactive experience, the control inputs originating from a first input device associated with a primary experience participant; provide the local control inputs to the interactive experience; provide audiovisual content associated with the interactive experience to at least one remote viewer computing device over a network; receive a command to initiate control sharing with a remote viewer; over the network, receive remote control inputs from a second input device associated with the remote viewer, the second input device being physically distinct from the first input device; and provide the remote control inputs to the interactive experience as if the remote control inputs had originated from the first input device, the first input device still being associated with the primary experience participant. In this example or any other example, the first input device has a different form factor from the second input device. In this example or any other example, the remote control inputs are relayed through the first input device before being provided to the interactive experience. In this example or any other example, the interactive experience is configured to support a plurality of control inputs, and the remote viewer is restricted to providing only a subset of control inputs of the plurality. In this example or any other example, the subset of control inputs permitted to the remote viewer is specified by the primary experience participant. In this example or any other example, the instructions are further executable to receive second remote control inputs from a second remote viewer, and provide the second remote control inputs to the interactive experience as if the second remote control inputs had originated from the first input device. In this example or any other example, the remote viewer and the second remote viewer each are restricted to providing only a subset of control inputs of a plurality of control inputs supported by the interactive experience, the second remote viewer being restricted to providing a different subset of control inputs than the remote viewer. In this example or any other example, the instructions are further executable to continue to receive local control inputs provided by the primary experience participant from the first input device, and provide the local control inputs to the interactive experience in tandem with the remote control inputs.

In an example, a method for controlling a video game comprises: receiving local control inputs at a local computing device executing the video game, the control inputs originating from a video game controller associated with a primary video game player; providing the local control inputs to the video game; providing audiovisual content output by the video game to at least one remote viewer computing device over a network; receiving a command to initiate control sharing with a remote viewer; over the network, receiving remote control inputs from an input device associated with the remote viewer, the input device being physically distinct and having a different form factor from the video game controller; and relaying the remote control inputs through the video game controller to the video game, the video game controller still being associated with the primary video game player, and the remote control inputs appearing, from the perspective of the video game, to originate from the video game controller.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above- described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for controlling an interactive experience, comprising:
receiving local control inputs at a local computing device facilitating the interactive experience, the control inputs originating from a first input device associated with a primary experience participant;
providing the local control inputs to the interactive experience;
providing audiovisual content associated with the interactive experience to at least one remote viewer computing device over a network;
receiving a command to initiate control sharing with a remote viewer;
over the network, receiving remote control inputs from a second input device associated with the remote viewer, the second input device being physically distinct from the first input device; and
providing the remote control inputs to the interactive experience as if the remote control inputs had originated from the first input device, the first input device still being associated with the primary experience participant.

2. The method of claim 1, where the first input device has a different form factor from the second input device.

3. The method of claim 2, where the first input device is a video game controller.

4. The method of claim 2, where the remote viewer computing device is configured to provide a graphical user interface to the remote viewer, the graphical user interface including virtual controls that mimic a layout of a video game controller, the virtual controls being manipulable by the remote viewer to provide the remote control inputs.

5. The method of claim 1, where the remote control inputs are relayed through the first input device before being provided to the interactive experience.

6. The method of claim 1, where the interactive experience is configured to support a plurality of control inputs, and the remote viewer is restricted to providing only a subset of control inputs of the plurality.

7. The method of claim 6, where the subset of control inputs permitted to the remote viewer is specified by the primary experience participant.

8. The method of claim 1, further comprising receiving second remote control inputs from a second remote viewer, and providing the second remote control inputs to the interactive experience as if the second remote control inputs had originated from the first input device.

9. The method of claim 8, where the remote viewer and the second remote viewer each are restricted to providing only a subset of control inputs of a plurality of control inputs supported by the interactive experience, the second remote viewer being restricted to providing a different subset of control inputs than the remote viewer.

10. The method of claim 1, further comprising continuing to receive local control inputs provided by the primary experience participant from the first input device, and providing the local control inputs to the interactive experience in tandem with the remote control inputs.

11. The method of claim 1, where the interactive experience is a video game.

12. A computing system, comprising:
a logic machine; and
a storage machine holding instructions executable by the logic machine to:
receive local control inputs at a local computing device facilitating the interactive experience, the control inputs originating from a first input device associated with a primary experience participant;
provide the local control inputs to the interactive experience;
provide audiovisual content associated with the interactive experience to at least one remote viewer computing device over a network;
receive a command to initiate control sharing with a remote viewer;
over the network, receive remote control inputs from a second input device associated with the remote viewer, the second input device being physically distinct from the first input device; and
provide the remote control inputs to the interactive experience as if the remote control inputs had originated from the first input device, the first input device still being associated with the primary experience participant.

13. The computing system of claim 12, where the first input device has a different form factor from the second input device.

14. The computing system of claim 12, where the remote control inputs are relayed through the first input device before being provided to the interactive experience.

15. The computing system of claim 12, where the interactive experience is configured to support a plurality of control inputs, and the remote viewer is restricted to providing only a subset of control inputs of the plurality.

16. The computing system of claim 15, where the subset of control inputs permitted to the remote viewer is specified by the primary experience participant.

17. The computing system of claim 12, where the instructions are further executable to receive second remote control inputs from a second remote viewer, and provide the second remote control inputs to the interactive experience as if the second remote control inputs had originated from the first input device.

18. The computing system of claim 17, where the remote viewer and the second remote viewer each are restricted to providing only a subset of control inputs of a plurality of control inputs supported by the interactive experience, the second remote viewer being restricted to providing a different subset of control inputs than the remote viewer.

19. The computing device of claim 12, where the instructions are further executable to continue to receive local control inputs provided by the primary experience participant from the first input device, and provide the local control inputs to the interactive experience in tandem with the remote control inputs.

20. A method for controlling a video game, comprising:
receiving local control inputs at a local computing device executing the video game, the control inputs originating from a video game controller associated with a primary video game player;
providing the local control inputs to the video game;
providing audiovisual content output by the video game to at least one remote viewer computing device over a network;
receiving a command to initiate control sharing with a remote viewer;
over the network, receiving remote control inputs from an input device associated with the remote viewer, the input device being physically distinct and having a different form factor from the video game controller; and
relaying the remote control inputs through the video game controller to the video game, the video game controller still being associated with the primary video game player, and the remote control inputs appearing, from the perspective of the video game, to originate from the video game controller.
